(19) United States
(12) Patent Application Publication
(10) Pub. No.: US 2010/0098472 A1
(43) Pub. Date: Apr. 22, 2010

(54) COPIER, AUTOMATIC DOCUMENT FEEDER FOR USE THEREIN, IMAGE SCANNING DEVICE, AND METHOD OF COPYING

(75) Inventors: Toshihiro KAWAMURA, Kyoto-shi (JP); Kenji KORENAGA, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/578,784

(22) Filed: Oct. 14, 2009

(30) Foreign Application Priority Data
Oct. 16, 2008 (JP) 2008-267769

(51) Int. Cl. G03G 15/00

(52) U.S. Cl. 399/374

(57) ABSTRACT

A copier includes an image scanning device having an ADF, and an image forming device having a duplex printing function that forms an image first on a back side surface of recording medium. The ADF includes an original tray, a separation unit, a first double-surface path, a second double-surface path, a discharge path, and a discharge tray. Originals with their front side surfaces facing upward can be placed on the original tray. The first double-surface path guides the original separated by the separation unit in such a manner that aback side surface of the original passes through a scanning position of a scanner unit. The second double-surface path reverses the original, which has passed through the first double-surface path and has had the back side surface scanned, and guides the original to the scanning position of the scanning unit so that the front side surface of the original can be scanned.

### CROSS-REFERENCE TO RELATED APPLICATIONS

This application claims priority under 35 U.S.C. 119 to Japanese Patent Application No. 2008-267769, filed on Oct. 16, 2008, which application is hereby incorporated by reference in its entirety.

### BACKGROUND OF THE INVENTION

1. Field of the Invention

The present invention relates to an image scanning device of a copier and, more specifically, to a configuration of an original transporting path that is provided in an Automatic Document Feeder (ADF) of the image scanning device.

2. Description of the Related Art

In an ADF used in a copier or the like, a conventionally-known ADF includes a path for reversing an original so as to scan both surfaces, that is, a front side surface and a back side surface of the original by one scanning unit.

For example, an ADF including the following configuration is known. That is, the ADF includes a sheet transporting path having an introducing path, a reversing path, and a discharging path. The introducing path introduces an original from one end of a scanning position to the scanning position. The reversing path is arranged in a circular shape in which the front or back of the original discharged from another end of the scanning position is reversed and introduced again from the other end to the scanning position. The discharging path discharges, to a discharging unit, the original discharged from the one end of the scanning position. The ADF includes a plurality of original-feeding rotary bodies and a driving unit, which are provided to the sheet transporting path. The plurality of original-feeding rotary bodies rotate in one direction in which a sheet of the original is fed. The driving unit drives the original-feeding rotary bodies and rotates in one direction.

A duplex ADF including the following configuration is also known. That is, the duplex ADF includes a tray on which originals are placed and a feeding unit that feeds the original, one sheet at a time from the tray. The duplex ADF further includes a transporting unit that feeds a first surface of the fed original to a scanning surface, reverses the front or back surface of the original after a scanning operation, feeds a second surface of the original to the scanning surface, and discharges the original after the second surface is scanned. The transporting unit includes a first transporting unit and a reversing unit. The first transporting unit feeds the first surface of the fed original to the scanning surface. The reversing unit reverses the front or back surface of the original without inverting a transportation state of the original (i.e., without performing a switchback operation in which the original is once stopped, and then transported backward) after the first surface is scanned. The transporting unit includes a second transporting unit. The second transporting unit feeds the second surface of the original, which has had the front or back surface thereof reversed by the reversing unit without the transportation state being inverted, from a direction that is opposite to a first-surface feeding direction to the scanning surface via a transporting section that shares a portion of the first transporting unit. Further, the transporting unit includes a branching unit and a discharging unit. The branching unit selectively branches a direction in which the original is fed from a position of the transporting section sharing the portion of the first transporting unit to the scanning surface via the first transporting unit and a direction in which the original is fed from the position of the transporting section to the scanning surface via the second transporting unit. The discharging unit discharges the original after the second surface is scanned.

Some copiers adopt a face-down discharging method that discharges a copy sheet (recording medium) such that a front side surface of the copy sheet faces downward. In such a case, by sequentially discharging the copy sheets with their front side surfaces facing downward, copies (i.e., the copy sheets on which image forming has been performed) can be stacked on a discharge tray in an order of pages of originals of the copies. In most copiers including the above configuration, a sheet transporting path is formed in a “C” shape in order to efficiently use the inside space of an image forming device, image forming is performed first on a backside surface of a copy sheet, the copy sheet is reversed through a switchback system or the like, and then, image forming is performed on a front side surface of the copy sheet. Accordingly, in an image forming unit, image information that corresponds to the scanned originals is formed into images on the copy sheets from page 2, page 1, page 4, page 3 . . . in this order.

However, when making a copy from both surfaces to both surfaces through the above image forming device, an order in which the originals are scanned may differ from an order in which the images are formed on the copy sheets. For example, when scanning the originals from the uppermost sheet of the stacked originals as in the above-described ADF, the originals are scanned from page 1 (a front side surface of the first original), page 2 (a back side surface of the first original), page 3 (a front side surface of the second original) . . . in this order. Accordingly, the image forming device cannot start the image forming operation until at least page 2 of the original has been scanned. Also, in the above-described duplex ADF, unless the image forming device starts the image forming operation after the completion of the second scanning operation, the copies cannot be discharged on the discharge tray in the order of the originals.

### SUMMARY OF THE INVENTION

In order to overcome the problems described above, preferred embodiments of the present invention provide a copier capable of making a copy from both surfaces to both surfaces with a configuration that can streamline a process from an original scanning operation through an image forming operation by matching an order in which originals are scanned with an order in which images are formed on recording media.

A first preferred embodiment of the present invention provides a copier including the following configuration. That is, the copier includes an image scanning device and an image forming device. The image scanning device includes a scanning unit arranged to scan image information of an original, and an ADF that can scan both surfaces of the original, that is, a first surface and a second surface of the original through the scanning unit. The image forming device includes a duplex printing function that forms images on a recording medium first from the second surface of the original. The ADF includes an original tray, a separation unit, a first double-surface path, a second double-surface path, a discharge path, and a discharge tray. The originals stacked with their first surfaces facing upward can be placed on the original tray. The separation unit separates the uppermost original from the originals stacked on the original tray. The first double-surface path guides the original separated by the separation unit such that the second surface of the original passes through a scanning position of the scanning unit. The second double-surface path reverses the original, which has passed through the first double-surface path and has had the second surface thereof scanned, and guides the original to the scanning position of the scanning unit so that the first surface of the original can be scanned. The discharge path is connected with the second double-surface path. The discharge tray is connected with the discharge path.

Since the first surface of the original is scanned after the second surface of the original is scanned, an order in which the image scanning device scans both surfaces of the original can match with an order in which the image forming device forms images on both surfaces of the recording medium. Accordingly, when performing a copying operation from both surfaces to both surfaces, the image information scanned by the image scanning device can be sequentially formed into images on the recording medium. Therefore, the time from the start of the scanning of the original to the completion of the image forming on both surfaces of the recording medium can be effectively reduced. Moreover, since the original is reversed by the second double-surface path and discharged onto the discharge tray with the first surface thereof facing downward, an order of the originals discharged onto the discharge tray can match with an order of the originals placed on the original tray. Therefore, the originals can be smoothly organized after the copying operation.

A second preferred embodiment of the present invention provides an ADF for use in the copier.

A third preferred embodiment of the present invention provides an image scanning device including the following configuration. That is, the image scanning device includes a scanning unit arranged to scan image information of an original, and an ADF that can scan both surfaces of the original, that is, a first surface and a second surface of the original through the scanning unit. The image scanning device includes a connection unit that enables connection with the image forming device including a duplex-printing function. The ADF includes an original tray, a separation unit, a first double-surface path, a second double-surface path, a discharge path, and a discharge tray. The originals stacked with their first surfaces facing upward can be placed on the original tray. The separation unit separates the uppermost original from the originals stacked on the original tray. The first double-surface path guides the original separated by the separation unit in such a manner that the second surface of the original passes through a scanning position of the scanning unit. The second double-surface path reverses the original, which has passed through the first double-surface path and has had the second surface scanned, and guides the original to the scanning position of the scanning unit so that the first surface of the original can be scanned. The discharge path is connected with the second double-surface path. The discharge tray is connected with the discharge path.

Thus, the first surface of the original is scanned after the second surface of the original is scanned. When the image scanning device is connected, via the connection unit, with the image forming device that forms an image on a recording medium first from the second surface of the original, an order in which both surfaces of the original are scanned can match with an order in which the image forming device forms images on both surfaces of the recording medium. Accordingly, when performing a copying operation from both surfaces to both surfaces, the image information scanned by the image scanning device can be sequentially transmitted to the image forming device via the connection unit, and the image information received by the image forming device can be sequentially formed on the recording medium. Therefore, the time from the start of the scanning of the original to the completion of the image forming on both surfaces of the recording medium can be effectively reduced. Moreover, since the original is reversed by the second double-surface path and discharged onto the discharge tray with the first surface thereof facing downward, an order of the originals discharged onto the discharge tray can match with an order of the originals placed on the original tray. Therefore, the originals can be smoothly organized after the copying operation.

The copier or the image scanning device preferably includes the following configuration. That is, the ADF includes a single-surface path and a route switching unit. The single-surface path reverses the original separated by the separation unit and guides the original to the scanning position of the scanning unit so that the first surface of the original is scanned. The route switching unit switches a route of the original either to the single-surface path or to the first double-surface path.

Thus, when scanning only one surface of the original, by switching the route of the original to pass through the single-surface path, the original can be reversed before being scanned and pass through the scanning position of the scanning unit in such a manner that the first surface is scanned. Accordingly, only by passing through the scanning position of the scanning unit once, the scanning operation can be completed, and thus, the single-surface scanning operation can be promptly performed. Further, since the original is reversed by the single-surface path and discharged onto the discharge tray with the first surface thereof facing downward, similarly to the duplex-scanning operation, the originals can be smoothly organized after the scanning operation.

In the copier or the image scanning device, a portion of the single-surface path is preferably shared with a portion of the second double-surface path.

Thus, members of the single-surface path and the second double-surface path, such as transportation rollers or the like, can be shared, and therefore, the number of components can be reduced. As a result, the number of manufacturing processes and a manufacturing cost can be reduced.

In the copier or the image scanning device, each of the single-surface path and the second double-surface path is preferably formed in a substantially U-shape including a turning portion, and a route between a junction portion, where a portion of the turning portion of the single-surface path and a portion of the turning portion of the second double-surface path join together, and the scanning position is preferably shared.

In the copier or the image scanning device, the ADF preferably includes an introducing path that substantially horizontally extends from the original tray, and a downstream end portion of the introducing path is preferably connected with an upstream end portion of the single-surface path and with an upstream end portion of the first double-surface path at the route switching unit.

In the copier or the image scanning device, the single-surface path is preferably formed in a substantially U-shape including the turning portion, and the downstream end portion of the introducing path is preferably connected with an upstream end portion of the discharge path via the single-surface path.

In the copier or the image scanning device, the scanning position is preferably located on a downstream side of the turning portion of the single-surface path.

In the copier or the image scanning device, the discharge path is preferably located below the first double-surface path.

In the copier or the image scanning device, the first double-surface path is preferably located below the single-surface path and preferably extends substantially linearly to the scanning position.

A fourth preferred embodiment of the present invention provides a copying method including the following steps. That is, the copying method includes a duplex scanning step and a duplex printing step. In the duplex scanning step, an image on the front and an image on the back, i.e., images on both surfaces of an original that is being transported are scanned by one scanning unit. In the duplex scanning step, the originals stacked on the original tray with their first surfaces facing upward are sequentially separated one sheet at a time from the uppermost original, and the duplex scanning operation is performed by one scanning unit first from the second surface of the original without performing a switchback operation during the transportation. In the duplex printing step, the scanned image of the first surface and the scanned image of the second surface of the original are formed into images on both surfaces of a recording medium. In the duplex printing step, the scanned image of the second surface of the original is formed into the image on the recording medium first.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a front view of a copier-and-facsimile Multi-Functional Peripheral (MFP) according to a preferred embodiment of the present invention.

FIG. 2 is a front cross-sectional view of an ADF.

FIG. 3 is a front cross-sectional view illustrating a state in which an original is guided to a single-surface path.

FIG. 4 is a front cross-sectional view illustrating a state in which a front side surface of the original guided to the single-surface path is being scanned by a scanner unit.

FIG. 5 is a front cross-sectional view illustrating a state in which a back side surface of an original guided to a first double-surface path is being scanned by the scanner unit.

FIG. 6 is a front cross-sectional view illustrating a state in which the original is reversed by a second double-surface path.

FIG. 7 is a front cross-sectional view illustrating a state in which a front side surface of the original guided to the second double-surface path is being scanned by the scanner unit.

### DETAILED DESCRIPTION OF PREFERRED EMBODIMENTS

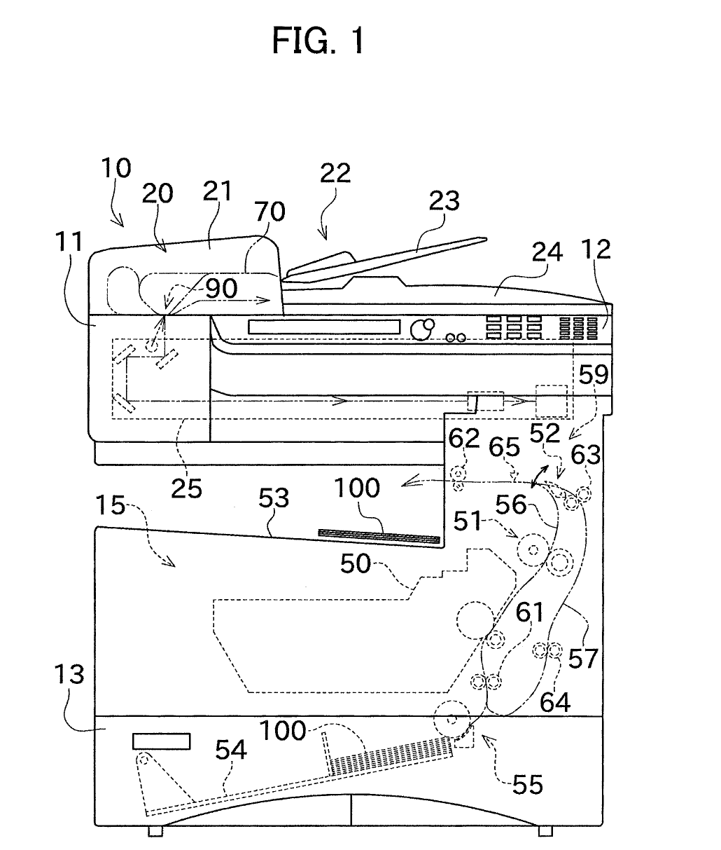

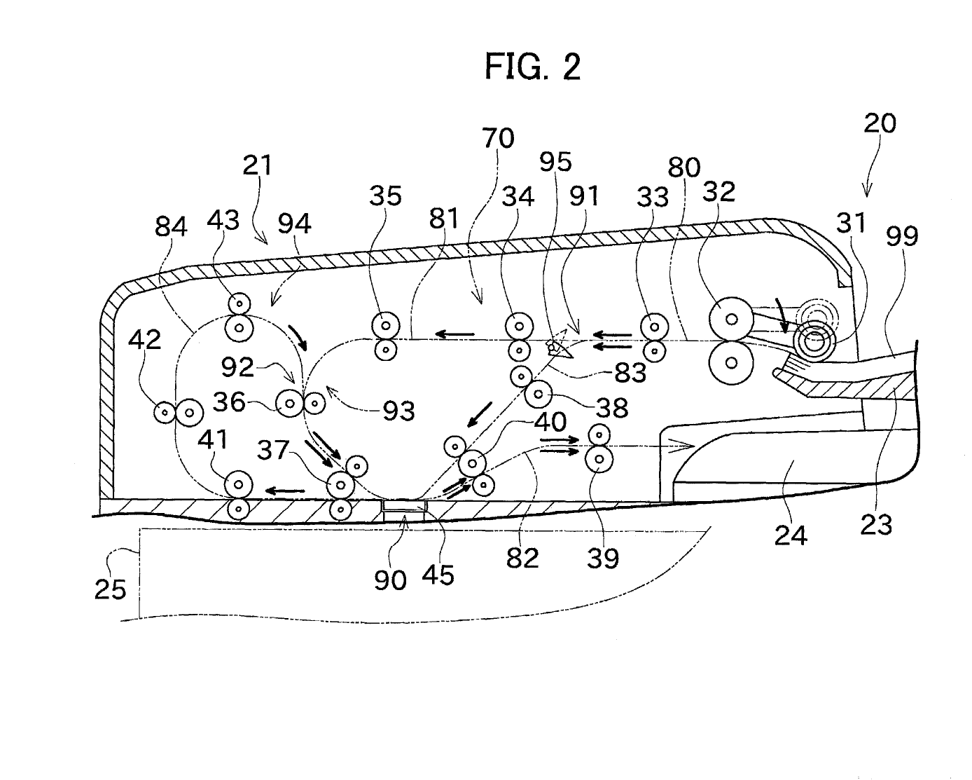

Preferred embodiments of the present invention will be described with reference to the drawings. FIG. 1 is a front view of a copier-and-facsimile MFP 10 defined as a copier according to a preferred embodiment of the present invention. FIG. 2 is a front cross-sectional view of a structure of an ADF 21 of the MFP 10.

As illustrated in FIG. 1, the copier-and-facsimile MFP 10 according to the present preferred embodiment includes a main body 11, an operation panel 12, a paper feeding cassette 13, and an image scanner device 20.

The image scanner device 20 functions as a flatbed scanner and an automatic document feeding scanner and includes the ADF 21. The operation panel 12 is provided for a user to give instructions to the MFP 10 regarding the number of copies, a copy mode (such as single-surface copying and double-surface copying), and a facsimile transmission destination or the like.

A portion of the image scanner device 20 is arranged at an upper portion of the main body 11. An image forming device 15 is provided in the main body 11. Further, the main body 11 includes a not-illustrated transmission/reception unit or the like for transmitting image data via a communication line. Facsimile communication can be performed through the transmission/reception unit. The paper feeding cassette 13 is arranged on a lower side of the main body 11, and sheets of recording paper 100 can be sequentially supplied to the image forming device 15.

A not-illustrated platen glass, on which originals to be scanned are placed, is provided on an upper surface of the main body 11. Further, an original table cover 22 is provided above the main body 11. The original table cover 22 can press and fix the originals onto the platen glass.

The ADF 21 is arranged on an upper surface side of the original table cover 22. The ADF 21 includes an original tray 23 and a discharge tray 24 provided below the original tray 23. In the ADF 21, an original transporting path 70 is arranged to connect the original tray 23 with the discharge tray 24.

The ADF 21 of the image scanner device 20 according to the present preferred embodiment adopts a system (a face-up system) in which one or a plurality of originals are placed on the original tray 23 in such a manner that its/their front side surface(s) (first surface(s)) faces/face upward. A mark or the like indicating that an original is to be placed with a front side surface thereof facing upward is displayed at a proper position of the original tray 23 through a suitable method such as an engraving method and a sealing method or the like.

Originals 99 placed with their front side surfaces facing upward are separated one sheet at a time from the top, transported along the original transporting path 70, and after passing through a scanning position 90 of a scanner unit 25, the original 99 is discharged onto the discharge tray 24. The ADF 21 will be described in detail later.

The scanner unit (scanning unit) 25 is provided at the upper portion of the main body 11. The scanner unit 25 preferably includes a light source, a reflection mirror, a condenser lens, and Charge Coupled Devices (CCD) or the like, and can scan the original 99 transported in the ADF 21. The scanner unit 25 irradiates the original 99 which has been transported through the original transporting path 70 with light radiated from the light source. Light reflected from the original 99 is introduced into the CCD and formed into an image. The CCD outputs an electric signal based on the original 99. After a proper conversion process is performed on the signal, the signal is transmitted to a later-described image forming unit 50 and printed, or the signal is transmitted to another facsimile machine via the communication line by the transmission/reception unit.

As described above, the image forming device 15 is provided in the main body 11. The image forming device 15 primarily includes the image forming unit 50, a fusing device 51, a switchback mechanism 59, and a discharge unit 53.

The paper feeding cassette 13 is arranged at a lower portion of the main body 11, and can be drawn on a front side of the machine (on the front side of FIG. 1). The image forming unit 50, the fusing device 51, the switchback mechanism 59, and the discharge unit 53 are arranged above the paper feed cassette 13.

The image forming device 15 includes a not-illustrated control unit arranged to control the image forming unit 50, later described rollers of each unit, and the switchback mechanism 59 or the like. The switchback mechanism 59 according to the present preferred embodiment primarily includes a recording paper discharge roller 62, a switch unit 52, and a switchback path 57.

A recording paper transporting path 56 is provided in the main body 11 to transport the recording paper 100 from the paper feeding cassette 13 to the tray-shaped discharge unit 53. The recording paper transporting path 56 is formed in a substantially “C” shape in the front view of FIG. 1, and connects from the paper feeding cassette 13 to the discharge unit 53.

The recording paper transporting path 56 is connected with the switchback path 57 provided to enable duplex printing. One end of the switchback path 57 is connected with the recording paper transporting path 56 on a downstream side of the fusing device 51, and the switch unit 52 is arranged in the vicinity of this connected portion. Another end of the switchback path 57 is connected with the recording paper transporting path 56 at a position located on a downstream side of a paper feeding unit 55 and on an upstream side of the image forming unit 50.

As illustrated in the front view of FIG. 1, the switchback path 57 forms a substantially U-turn shaped path by being combined with a portion of the recording paper transporting path 56. This U-turn shaped path is formed in such a manner that the recording paper 100 having passed through the image forming unit 50 once can be reversed and introduced into the image forming unit 50 once again, and thus, duplex printing can be achieved by the one image forming unit 50.

Next, each unit of the image forming device 15 will be described in detail. First, each unit provided to the recording paper transporting path 56 will be described from the upstream side to the downstream side.

A flapper 54 for stacking the recording papers 100 is rotatably provided at a bottom portion of the paper feeding cassette 13. The flapper 54 is biased upward by a not-illustrated spring. The paper feeding unit 55 including a paper feeding roller and a paper feeding pad or the like is arranged above the flapper 54. The paper feeding roller of the paper feeding unit 55 can make contact with the uppermost recording paper 100 stacked on the flapper 54.

A pair of recording paper transporting rollers 61 is arranged on a downstream side of the paper feeding cassette 13. While nipping the recording paper 100, the recording paper transporting rollers 61 feed the recording paper 100 along the recording paper transporting path 56 to the image forming unit 50 provided on the downstream side.

The recording paper transporting path 56 is formed in “C” shape as if to curve as described above, and the image forming unit 50 is provided on an inner peripheral side of the recording paper transporting path 56 and faces the recording paper transporting path 56. The image forming unit 50 includes, for example, a photoconductive drum, a charger, an exposure head, a developer, and a transfer roller or the like. The image forming unit 50 can transfer (form) a toner image in accordance with image information onto the recording paper 100 that has been transported by the recording paper transporting rollers 61. The recording paper 100 on which the toner image has been formed by the image forming unit 50 is transported along the recording paper transporting path 56 to the fusing device 51 provided on the downstream side.

The fusing device 51 includes a rotationally driven heat roller and a press roller arranged to face the heat roller. The fusing device 51 uses heat of the highly-heated heat roller and pressure of the press roller to melt toner of the toner image that has been transferred onto the recording paper 100 by the image forming unit 50, and thus fuses the toner onto the recording paper 100.

As described above, the switch unit 52 including a rotatable nail portion or the like is provided at the connected portion between the recording paper transporting path 56 on the downstream side of the fusing device 51 and the switchback path 57. The recording paper 100 can be guided to the switchback path 57 by the rotation of the nail portion of the switch unit 52. In the recording paper transporting path 56, a switchback sensor 65 is provided on a slightly downstream side of the connected portion connected with the switchback path 57.

The recording paper discharge roller 62 is arranged on a further downstream side of the switchback sensor 65. The recording paper discharge roller 62 can switch a rotational direction between a forward direction (i.e., a clockwise direction in FIG. 1) and a backward direction (i.e., a counterclockwise direction in FIG. 1).

The discharge unit 53 is connected to an end portion of the recording paper transporting path 56 on a further downstream side of the recording paper discharge roller 62. By passing through the curved recording paper transporting path 56, the recording paper 100 on which the image has been formed by the image forming unit 50 is discharged onto the discharge unit 53 such that the image-formed surface faces downward (face-down discharge).

Recording paper transporting rollers 63 and 64 are provided to the switchback path 57, and the recording paper 100 fed to the switchback path 57 can be transported to a position located on an upstream side of the recording paper transporting rollers 61.

With the above configuration, when an instruction is given through the operation panel 12 or the like to perform single-surface printing (for example, a single-surface copy mode), the image forming device 15 operates as follows. That is, when the paper feeding unit 55 is driven at the start of the printing, the uppermost recording paper 100 placed on the paper feeding cassette 13 is separated and picked up by the paper feeding roller, and transported towards the recording paper transporting path 56. Then, the recording paper 100 is transported to the downstream side along the recording paper transporting path 56, and a desired toner image is formed when the recording paper 100 passes through the image forming unit 50. The recording paper 100 passes through the fusing device 51, and thus, the toner image is fused on the recording paper 100. Then, the recording paper 100 is discharged onto the discharge unit 53 under the state in which the image-formed surface faces downward by the recording paper discharge roller 62 that is driven to rotate in the forward direction.

Similarly, when an instruction is given through the operation panel 12 or the like to perform duplex printing (for example, double-surface copying), a sheet of recording paper 100 is picked up from the paper feeding cassette 13, and passes through the image forming unit 50 along the recording paper transporting path 56. Thus, a toner image is formed. However, in the MFP 10 (image forming device 15) according to the present preferred embodiment, in the case of duplex printing, in which images are formed on the front and back of one recording paper 100, when the recording paper 100 passes through the image forming unit 50 for the first time, a toner image of a back side surface (a second surface) is formed first.

The recording paper 100 having the image formed on its back side surface passes through the fusing device 51, and is transported further downstream along the recording paper transporting path 56. Then, the recording paper 100 is transported while being nipped by the recording paper discharge roller 62 etc., and a trailing edge of the recording paper 100 passes through the switchback sensor 65. Having detected such passing of the trailing edge of the recording paper 100, the switchback sensor 65 transmits a detection signal to the control unit. Having received the detection signal, the control unit drives the recording paper discharge roller 62 in the backward direction, and operates the switch unit 52 at proper timing to guide the recording paper 100 to the switchback path 57. Thus, the recording paper 100 is fed to the switchback path 57.

In the switchback path 57, the recording paper 100 is transported downstream by driving the recording paper transporting rollers 63 and 64 and introduced into the recording paper transporting path 56. Further, the recording paper 100 is transported downstream by the recording paper transporting rollers 61, and passes through the image forming unit 50 again. Since the recording paper 100 has been reversed by passing through the switchback path 57, a surface that is opposite to the surface having the image that was formed when the recording paper 100 passed through the image forming unit 50 for the first time faces the image forming unit 50. Then, this time (when the recording paper 100 passes through for the second time), the image forming unit 50 forms a toner image of a front side surface (a first surface) on the recording paper 100.

The recording paper 100 on which the image of the front side surface has been formed passes through the fusing device 51, and is further transported downstream along the recording paper transporting path 56. After the recording paper discharge roller 62 feeds the recording paper 100 to the switchback path 57 by rotating in the backward direction as described above, the recording paper discharge roller 62 is switched at proper timing to rotate in the forward direction again. Accordingly, the recording paper 100 on which the duplex printing has been performed is discharged onto the discharge unit 53 by the recording paper discharge roller 62 under the state in which the front side surface (the first surface) faces downward.

In other words, in the case of duplex printing, the image that corresponds to the back side surface of the recording paper 100 is printed first on the recording paper 100 that has been fed by the paper feeding unit 55, and then, the image that corresponds to the front side surface is printed. Therefore, for example, when duplex-printing images of six pages, the image forming unit 50 forms the images on the recording papers 100 from page 2, page 1, page 4, page 3, page 6, and page 5 in this order.

Then, the recording paper 100 is discharged onto the discharge unit 53 such that the front side surface having the image information printed thereon faces downward. Thus, even when performing the duplex printing on two or more recording papers 100, the recording papers 100 can be discharged onto the discharge unit 53 in an order that matches an order of the pages. For example, when duplex-printing images of six pages, the first recording paper 100 is discharged with page 1 facing downward, the second recording paper 100 is discharged with page 3 facing downward on the first recording paper 100, and the third recording paper 100 is discharged with page 5 facing downward on the second recording paper 100. Therefore, a user does not need to reorder the printed recording papers 100, which thereby achieves good workability.

As described above, the image forming device 15 according to the present preferred embodiment includes a duplex-printing function which prints the front side surface (the first surface) after printing the back side surface (the second surface) of the recording paper 100, and then discharges the recording paper 100 onto the discharge unit 53 under the state in which the front side surface faces downward.

Next, with reference to FIG. 2, a configuration of the ADF 21 of the image scanner device 20 will be described in detail. The image scanner device 20 includes the scanner unit 25 for scanning the original 99 and the ADF 21 for transporting the original 99. A contact glass 45 is arranged at a bottom portion of the ADF 21 to scan the original 99. The contact glass 45 corresponds to the scanning position 90 of the scanner unit 25. The contact glass 45 also faces a lower side surface of the original 99 that passes through the scanning position 90.

Inside the ADF 21, the curved original transporting path 70 is arranged to pass through the scanning position 90 and to connect the original tray 23 with the discharge tray 24. The original transporting path 70 includes an introducing path 80 arranged to introduce the original 99, a single-surface path 81 used to scan one surface of the original 99, a first double-surface path 83 and a second double-surface path 84 which are used to scan both surfaces, and a discharge path 82 arranged to discharge the scanned original 99. These paths of the original transporting path 70 will be described below.

As illustrated in FIG. 2, in a direction away from the original tray 23, the introducing path 80 substantially horizontally extends inside the ADF 21 from a position where the original 99 placed on the original tray 23 is supplied. A pick-up roller (pick-up unit) 31 is arranged on a route of the introducing path 80. A separation unit 32 including a separation roller and an opposing roller, etc. that faces the separation roller is arranged on a downstream side of the pick-up roller 31 on the route of the introducing path 80.

The pick-up roller 31 can swing around a rotational axis of the separation roller. When the ADF 21 is not being operated, the pick-up roller 31 is held at a position located on an upper side indicated by the double-dashed line (i.e., at a position that is located above the original 99 and away from the original 99). When picking up the original 99, the pick-up roller 31 swings downward, and makes contact (at a position indicated by the solid line in FIG. 2) with an edge portion of the uppermost original 99 from the originals 99 stacked on the original tray 23. In such a state, the pick-up roller 31 rotates, and thus, the uppermost original 99 stacked on the original tray 23 is fed to the separation unit 32.

The original 99 fed to the separation unit 32 by the pick-up roller 31 is nipped between the separation roller and the opposing roller of the separation unit 32. Then, the originals 99 are separated one sheet at a time by the rotationally-driven separation roller and opposing roller, and fed to a resist roller 33 provided on a downstream side. The resist roller 33 preferably includes a pair of rollers arranged on the downstream side of the separation unit 32 on the route of the introducing path 80. The resist roller 33 temporarily stops and slacks a leading end side of the original 99 transported by the separation unit 32, and transports the original 99 to the downstream side after a prescribed period of time while eliminating the slack. Thus, oblique movement of the original 99 can be corrected.

A branching portion 91, which is a junction of three branches, is provided on a downstream side of the resist roller 33, where a downstream end portion of the introducing path 80, an upstream end portion of the single-surface path 81, and an upstream end portion of the first double-surface path 83 are connected with each other. A switching unit (route switching unit) 95 is provided at the branching portion 91. The switching unit 95 includes a nail-shaped rotary member and a not-illustrated solenoid. By rotating the rotary member by the solenoid, the switching unit 95 can sort the original 99, which has been transported from the introducing path 80 by the drive of the resist roller 33, into the single-surface path 81 or into the first double-surface path 83. The switching of the route between the single-surface path 81 and the first double-surface path 83 is controlled based on designation or the like of the copy mode (single-surface copying/double-surface copying) performed through the operation panel 12.

The single-surface path 81 will be described. In the front view, the single-surface path 81 has a laterally-facing U shape, and the downstream end portion of the introducing path 80 and an upstream end portion of the discharge path 82 are connected via the single-surface path 81. More specifically, the single-surface path 81 extends from the branching portion 91 substantially horizontally in the direction away from the original tray 23, and after passing above the contact glass 45 (scanning position 90), the single-surface path 81 curves its direction downward. Then, the single-surface path 81 forms a turning portion 93 by extending while curving towards the scanning position 90 (i.e., towards a side of the discharge tray 24), and reaches the scanning position 90. A pair of transportation rollers 34, a pair of transportation rollers 35, a pair of transportation rollers 36, and a row of three rollers 37 are provided on a route of the single-surface path 81. By driving these rollers, the original 99 guided to the single-surface path 81 can be transported to the scanning position 90 provided at the bottom portion of the ADF 21. A transportation direction of the original 99 in which the original 99 passes through the scanning position 90 after being transported through the single-surface path 81 is opposite to the direction in which the original 99 is picked up and fed by the pick-up roller 31 to the introducing path 80.

In the present preferred embodiment, the ADF 21 is configured such that the scanning position 90 of the scanner unit 25 is located on a downstream side of the turning portion 93 of the single-surface path 81. Accordingly, the original 99 is transported in a reversed state by the U-shaped single-surface path 81 to the scanning position 90. As described above, the originals 99 are placed on the original tray 23 with their front side surfaces facing upward. Therefore, the original 99 is transported by the single-surface path 81 such that the front side surface thereof faces downward to face a scanning surface (contact glass 45) of the scanner unit 25 at the scanning position 90.

The original 99 which has had image information thereof scanned at the scanning position 90 of the scanner unit 25 is introduced into the discharge path 82. The discharge path 82 is arranged below the first double-surface path 83. After extending slightly obliquely above from the scanning position 90, the discharge path 82 extends substantially horizontally to be connected to the discharge tray 24. A row of three rollers 40 and transportation rollers 39 are provided on a route of the discharge path 82, and by driving these rollers, the original 99 can be discharged onto the discharge tray 24. The row of three rollers 40 (and the row of three rollers 37) will be described later.

Next, the first double-surface path 83 will be described. The first double-surface path 83 is arranged below the single-surface path 81, and substantially linearly heads for the scanning position 90. Transportation rollers 38 and the row of three rollers 40 are provided on a route of the first double-surface path 83, and by driving these rollers, the original 99 can be transported to the scanning position 90. A transportation direction in which the original 99 that has passed through the first double-surface path 83 passes through the scanning position 90 is opposite to the transportation direction in which the original 99 that has passed through the single-surface path 81 passes through the scanning position 90.

Unlike the single-surface path 81, the first double-surface path 83 transports the original 99 to the scanning position 90 without reversing the original 99. Accordingly, when the original 99 placed on the original tray 23 with its front side surface facing upward is transported to the scanning position 90 via the first double-surface path 83, a back side surface of the original 99 is scanned. The first double-surface path 83 is connected with an upstream end portion of the second double-surface path 84 at the scanning position 90 located in the vicinity of the bottom portion of the ADF 21.

Next, the second double-surface path 84 will be described. As illustrated in FIG. 2, the second double-surface path 84 has a substantially U shape so as to reverse the original 99 at a turning portion 94. More specifically, after extending substantially horizontally (in a direction away from the discharge tray 24) from the scanning position 90 at the bottom portion of the ADF 21, the second double-surface path 84 curves its direction upward. Then, the second double-surface path 84 forms the turning portion 94 by curving towards the original tray 23, and then curves downward. The second double-surface path 84 then extends to the scanning position 90 while curving towards the scanning position 90 (i.e., towards the side of the discharge tray 24).

The row of three rollers 37 and transportation rollers 41, 42, 43, and 36 are arranged on a route of the second double-surface path 84. With this configuration, the original 99, which has passed through the first double-surface path 83, has had the back side surface thereof scanned at the scanning position 90, and has been guided to the second double-surface path 84, is reversed at the turning portion 94 and guided again to the scanning position 90 with its surface reversed upside down. Accordingly, when passing through the scanning position 90 for the second time, the front side surface of the original 99 is scanned. A direction in which the original 99 having passed through the second double-surface path 84 passes through the scanning position 90 is opposite to the direction in which the original 99 having passed through the first double-surface path 83 passes through the scanning position 90.

In the present preferred embodiment, the single-surface path 81 and the second double-surface path 84 share a portion. More specifically, a portion of the turning portion 93 of the single-surface path 81 and a portion of the turning portion 94 of the second double-surface path 84 join together at a junction portion 92, and a route (junction route) from the junction portion 92 to the scanning position 90 is shared by the single-surface path 81 and the second double-surface path 84. Thus, the members for transporting the original 99 such as the transportation rollers 36 and the row of three rollers 37 or the like can be shared, which thereby can reduce the number of components. Further, as described in the present preferred embodiment, by sharing, by the single-surface path 81 and the second double-surface path 84, the portion of the route for reversing the original 99, the original transporting path 70 can be downsized, and the inner space of the ADF 21 can be effectively used.

The row of three rollers 40 will be described. The row of three rollers 40 preferably include a centrally arranged driving roller and two driven rollers arranged to sandwich the driving roller. The row of three rollers 40 are arranged in the vicinity of the scanning position 90 such that the driving roller is sandwiched between the first double-surface path 83 and the discharge path 82. One of the two driven rollers nips the first double-surface path 83 and faces the driving roller, and another one of the driven rollers nips the discharge path 82 and faces the driving roller. With this configuration, by driving and rotating the centrally arranged driving roller, the driven rollers adjacent to the driving roller can be simultaneously rotated. Therefore, the number of components can be reduced, and the limited space inside the ADF 21 can be effectively used.

The row of three rollers 37 preferably has a similar configuration to that of the row of three rollers 40. A driving roller of the row of three rollers 37 is arranged inside the curved second double-surface path 84 (in the vicinity of the scanning position 90) in such a manner that the driving roller is vertically sandwiched by the second double-surface path 84. One of two driven rollers nips the second double-surface path 84 and faces the driving roller at the bottom portion of the ADF 21 in the vicinity of the scanning position 90. Another one of the driven rollers is arranged obliquely above the driving roller, and faces the driving roller across the junction route.

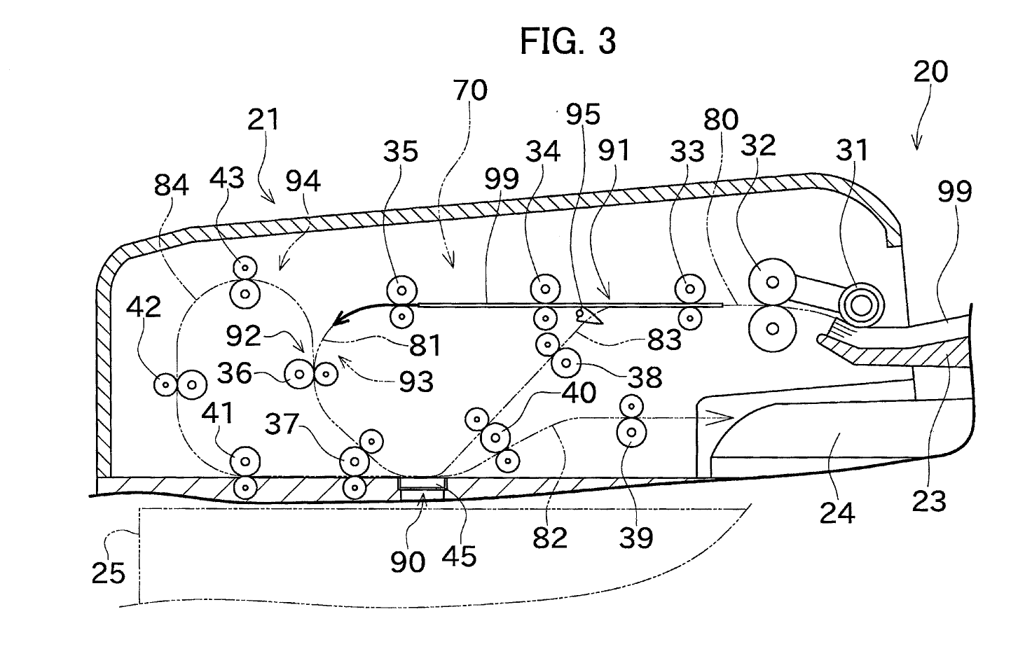

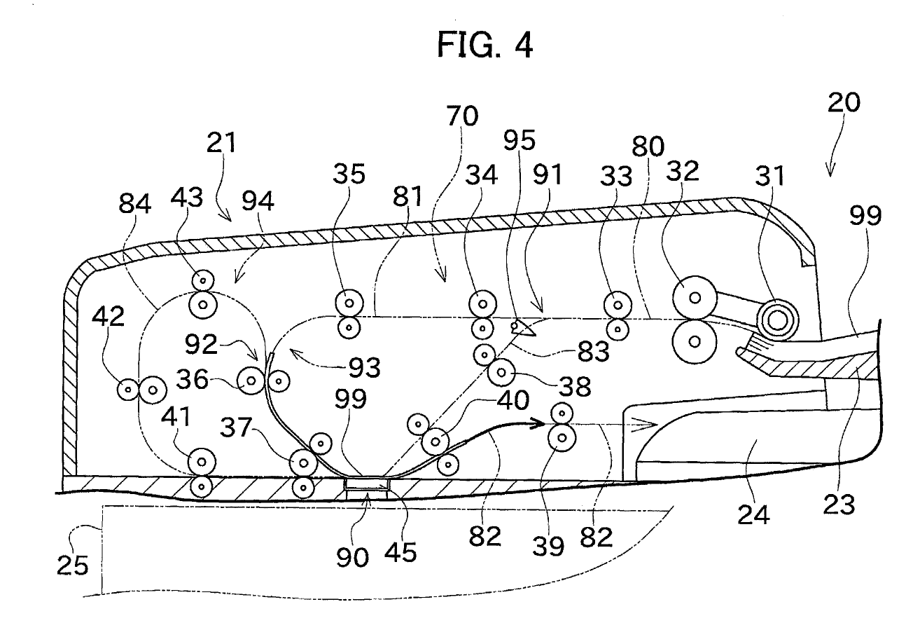

Next, with reference to FIGS. 3 and 4, an operation of scanning only one surface (front side surface) by transporting the original 99 by the above-described ADF 21 will be described. FIG. 3 is a front cross-sectional view illustrating a state in which the original 99 is guided to the single-surface path 81. FIG. 4 is a front cross-sectional view illustrating a state in which the front side surface of the original 99 guided to the single-surface path 81 is being scanned by the scanner unit 25.

A user instructs the MFP 10 to designate a single-surface copy mode by operating the operation panel 12 or the like of FIG. 1, places the original 99 on the original tray 23, and then instructs to start a copying operation. The pick-up roller 31 and the separation unit 32 of the ADF 21 are driven, and the switching unit 95 is controlled to switch the route of the original 99 to the single-surface path 81. Thus, as illustrated in FIG. 3, the original 99, which has been separated by the separation unit 32 and has passed through the introducing path 80, is guided to the single-surface path 81 at the branching portion 91 by the switching unit 95. Since the original 99 is placed on the original tray 23 with its front side surface facing upward, the front side surface of the original 99 faces upward in the state illustrated in FIG. 3. As described above, since the single-surface path 81 is formed in a U shape, the original 99 turns around at the turning portion 93.

As illustrated in FIG. 4, the original 99, which has been reversed at the turning portion 93 of the single-surface path 81, is guided to the scanning position 90 of the scanner unit 25. Then, the content of the original 99 is scanned by the scanning surface (contact glass 45) of the scanner unit 25 positioned on a lower side of the scanning position 90. In the state illustrated in FIG. 4, since the original 99 has been reversed at the turning portion 93, a back side surface of the original 99 faces upward at the scanning position 90. Therefore, a lower side surface, that is, the front side surface of the original 99, which has passed through the single-surface path 81, is scanned at the scanning position 90. After passing through the discharge path 82, the original 99, which has had its front side surface scanned, is discharged onto the discharge tray 24 with the front side surface facing downward (face-down discharge).

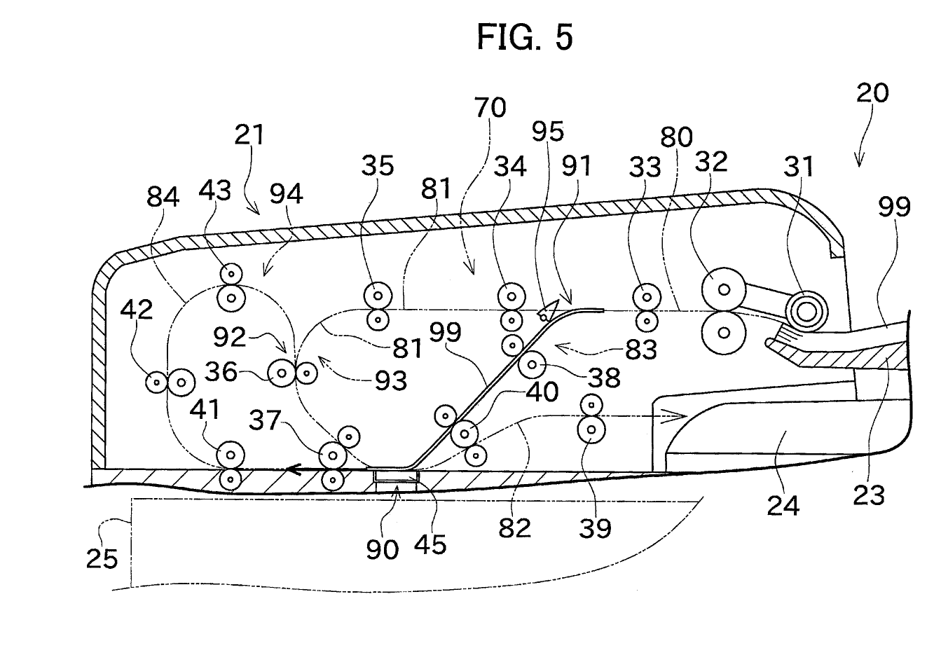

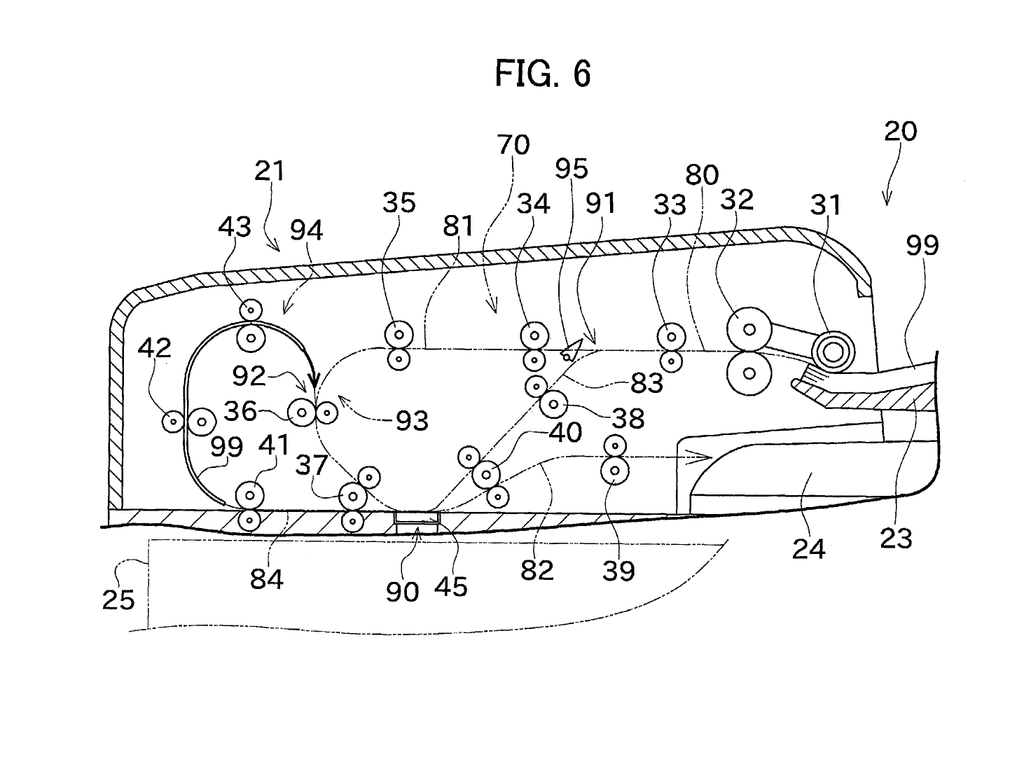

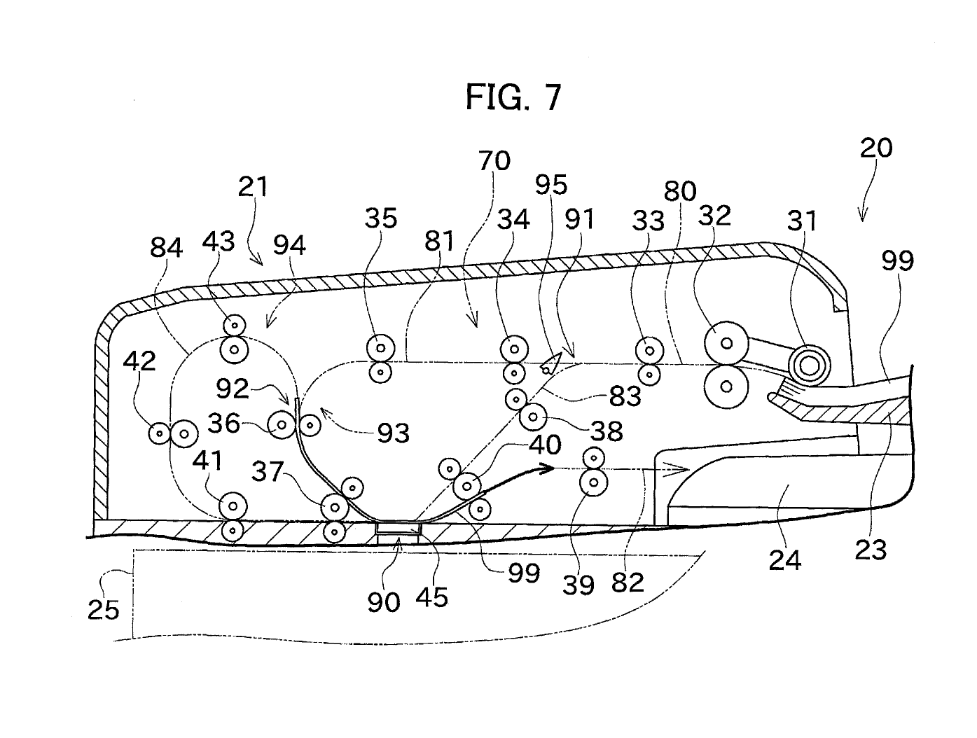

Next, with reference to FIGS. 5 through 7, an operation of scanning both sides of the original 99 will be described. FIG. 5 is a front cross-sectional view illustrating a state in which a backside surface of the original 99 guided to the first double-surface path 83 is being scanned by the scanner unit 25. FIG. 6 is a front cross-sectional view illustrating a state in which the original 99 is being reversed in the second double-surface path 84. FIG. 7 is a front cross-sectional view illustrating a state in which a front side surface of the original 99 guided to the second double-surface path 84 is being scanned by the scanner unit 25.

The user instructs the MFP 10 to designate a duplex copy mode by operating the operation panel 12 or the like of FIG. 1, places the original 99 on the original tray 23, and instructs to start a copying operation. Similarly to the above-described single-surface copy mode, the pick-up roller 31 and the separation unit 32 are driven, but the switching unit 95 is controlled to switch the route of the original 99 to the first double-surface path 83. Accordingly, as illustrated in FIG. 5, the original 99, which has been separated by the separation unit 32 and has passed through the introducing path 80, is guided to the first double-surface path 83 at the branching portion 91 by the switching unit 95. The original 99 introduced into the first double-surface path 83, which extends obliquely downward, is transported substantially linearly from the branching portion 91 to the scanning position 90.

Since the original 99 is placed on the original tray 23 with its front side surface facing upward, the front side surface of the original 99 faces upward in the state illustrated in FIG. 5. Since the contact glass 45 is arranged on a lower side of the first double-surface path 83 at the scanning position 90, and the original 99 is transported through the first double-surface path 83 without being reversed, a lower side surface of the original 99, that is, aback side surface of the original 99 is scanned first at the scanning position 90. Having passed through the scanning position 90, the original 99 is transported to the second double-surface path 84.

Having been guided to the second double-surface path 84, the original 99 is reversed as illustrated in FIG. 6 by the second double-surface path 84, which makes a turn. As a result, the surface of the original 99 is reversed upside down, and the front side surface of the original 99 faces downward. Then, the original 99 passes through the junction portion 92 where the single-surface path 81 joins, and is guided to the scanning position 90. Since the back side surface of the original 99 faces upward in the state illustrated in FIG. 7, the front side surface of the original 99 is scanned at the scanning position 90. Having had the front side surface scanned, the original 99 passes through the discharge path 82 and is discharged onto the discharge tray 24 with the front side surface thereof facing downward (face-down discharge).

As described above, when scanning both sides of the original 99 by the image scanner device 20 through the ADF 21, the back side surface of the original 99 is scanned first, and then, the front side surface of the original 99 is scanned. Accordingly, for example, when transporting and scanning through the ADF 21 double-surfaced originals on which six pages (page 1 through page 6) are printed from a front side and a back side of the first sheet, a front side and a back side of the second sheet, and a front side and a back side of the third sheet in this order, the originals are scanned from page 2, page 1, page 4, page 3, page 6, and page 5.

The page order for the duplex scanning by the ADF 21 corresponds to the page order of the duplex printing by the image forming unit 50. Accordingly, in the configuration of the present preferred embodiment, by matching an order in which the originals are scanned by the image scanner device 20 with a printing order of the image forming device 15, the copying operation from both surfaces to both surfaces can be effectively performed.

In other words, in a conventional configuration, even when the originals are scanned from the first sheet, the originals are scanned from page 1, page 2, page 3 . . . in this order, and the original scanning order cannot match with the image forming order. However, in the configuration of the present preferred embodiment, the printing can be immediately started at the completion of the scanning of each page of the originals. Therefore, the time from the start of duplex copying instructed through the operation panel 12 to the completion of the printing on both sides of the recording paper 100 can be effectively reduced. Moreover, since the image information of the scanned original is immediately printed, a period of time for copying can be reduced by reducing the number of times the image information is stored in a buffer memory, and at the same time, a storage capacity of the image buffer memory can be reduced.

As described above, the MFP 10 defined as a copier according to the present preferred embodiment includes the following configuration. That is, the MFP 10 includes the image scanner device 20 and the image forming device 15. The image scanner device 20 includes one scanner unit 25 arranged to scan the image information of the original 99 and the ADF 21 that can scan, through the scanner unit 25, both surfaces of the original 99, that is, the front side surface (first surface) and the back side surface (second surface) of the original 99. The image forming device 15 includes the duplex printing function that forms an image on the recording paper 100 first from the back side surface (second surface) of the original 99. The ADF 21 includes the original tray 23, the separation unit 32, the first double-surface path 83, the second double-surface path 84, the discharge path 82, and the discharge tray 24. The originals 99 with their front side surfaces facing upward can be placed and stacked on the original tray 23. The separation unit 32 separates the uppermost original 99 from the originals 99 stacked on the original tray 23. The first double-surface path 83 guides the original 99 separated by the separation unit 32 such that the back side surface of the original 99 passes through the scanning position 90 of the scanner unit 25. The second double-surface path 84 reverses the original 99, which has passed through the first double-surface path 83 and has had its back side surface scanned, and guides the original 99 to the scanning position 90 of the scanner unit 25 so that the front side surface of the original 99 is scanned. The discharge path 82 is connected with the second double-surface path 84. The discharge tray 24 is connected with the discharge path 82.

Thus, images on both sides of the original 99 can be scanned by one scanner unit 25 without performing a switchback operation (in which the original 99 is once stopped, and then a transportation direction is inverted) on the original 99. Further, since the front side surface of the original 99 is scanned after the back side surface of the original 99 is scanned, the order in which the image scanner device 20 scans the both surfaces of the original 99 can match with the order in which the image forming device 15 forms the images on both surfaces of the recording paper 100. Accordingly, when performing a copying operation from both surfaces to both surfaces, the image information scanned by the image scanner device 20 is sequentially formed into an image on the recording paper 100. Therefore, the time from the start of the scanning of the original 99 to the completion of the image forming on both surfaces of the recording paper 100 can be effectively reduced. Furthermore, since the original 99 is reversed by the second double-surface path 84, and discharged onto the discharge tray 24 with the front side surface thereof facing downward, the order of the originals 99 discharged onto the discharge tray 24 of the image scanner device 20 can match with the order in which the originals 99 were placed on the original tray 23. Accordingly, the originals 99 can be smoothly organized after the copying operation.

The MFP 10 according to the present preferred embodiment includes the following configuration. That is, the ADF 21 includes the single-surface path 81 and the switching unit 95. The single-surface path 81 reverses the original 99 separated by the separation unit 32 and guides the original 99 to the scanning position 90 of the scanner unit 25 so that the front side surface (first surface) of the original 99 is scanned. The switching unit 95 switches the route of the original 99 either to the single-surface path 81 or to the first double-surface path 83.

Thus, when scanning only one surface of the original 99, the route of the original 99 can be switched to the single-surface path 81 so that the original 99 is reversed before being scanned and passes through the scanning position 90 of the scanner unit 25 in such a manner that the front side surface is scanned. Thus, bypassing through the scanning position 90 of the scanner unit 25 only once, the scanning operation can be completed, and the single-surface scanning operation can be promptly performed. Moreover, since the original 99 is reversed by the single-surface path 81 and discharged onto the discharge tray 24 with the front side surface thereof facing downward, similarly to the duplex scanning operation, the originals 99 can be smoothly organized after the scanning operation.

In the MFP 10 according to the present preferred embodiment, the single-surface path 81 and the second double-surface path 84 share a portion.

Therefore, some members such as the transportation rollers and the row of three rollers 37, etc., provided for the single-surface path 81 and the second double-surface path 84 can be shared, and thus, the number of components can be reduced. As a result, the number of manufacturing processes and a manufacturing cost can be reduced.

The preferred embodiments of the present invention have been described above, however, the above-described configuration may be modified as follows.

In the above preferred embodiment, the single-surface path 81 and the second double-surface path 84 preferably join together, however, such a configuration may be modified such that the single-surface path 81 and the double-surface path 84 do not join together, and they separately guide the original 99 to the scanning position 90 via separate routes.

Further, the single-surface path 81 may be omitted from the configuration of the above preferred embodiment. When performing a single-surface scanning operation on the original 99 in such a configuration, the original 99 may be controlled to be transported once along the first double-surface path 83 (without performing a scanning operation thereon), to pass through the second double-surface path 84, where the original 99 is reversed, and then have the front side surface thereof scanned at the scanning position 90. Thus, the configuration of each unit of the original transporting path 70 can be appropriately changed in accordance with circumstances.

In the above preferred embodiment, a switchback operation is preferably performed on the recording paper 100 by the switchback mechanism 59 for the duplex printing of the recording paper 100, however, the present invention is not limited to such configuration. In other words, any image forming device of a proper type may be adopted as long as the image forming is performed first on the back side surface (second surface) of the recording paper 100. For example, an image forming device may be adopted in which, after the image forming is performed first on the back side surface of the recording paper 100, the recording medium makes a U-turn (without a switchback operation performed thereon), and the front side surface is guided to the image forming unit. Alternatively, an image forming device may be adopted in which a first image forming unit for a back side surface is provided on the upstream side of the recording paper transporting path, a second image forming unit for a front side surface is provided on the downstream side of the first image forming unit, and thus the back side surface is formed into an image first.

In the above-described preferred embodiment, a reduction optical system scanner unit 25 is preferably used as the scanning unit, however, for example, a contact image sensor or the like may be used as the scanning unit in place of the above scanner unit 25. Moreover, in the above-described preferred embodiment, the scanner unit 25 is preferably provided to the main body 11, however, the scanning unit may be provided in the ADF. Thus, the configuration of the scanning unit may be appropriately changed in accordance with circumstances.

The configuration according to the above preferred embodiment may be applied not only to a copier-and-facsimile MFP but also, for example, to a stand-alone copier.

The present invention may be applied, for example, to a stand-alone image scanner device (image scanning device) described below. That is, the image scanner device includes a scanner unit, an ADF, and a connection unit that enables connection with a printer (image forming device). The scanner unit may adopt any proper configuration, such as a reduction optical system or a contact image sensor or the like. The connection unit can be connected with a network such as a Local Area Network (LAN) or the like, and image information of an original scanned by the scanner unit can be transmitted to the printer via the network. The printer is connected with the image scanner device via the network, and includes a duplex printing function that first prints (i.e., performs an image forming operation on) a back side surface (second surface) of the original scanned by the image scanner device on a recording paper (recording medium). Since the ADF has a similar configuration to that of the above-described preferred embodiment, a detailed description thereof is omitted.

With the above configuration, by instructing the image scanner device to scan both surfaces of an original and to perform a duplex printing operation through the printer, the duplex copying of the original can be achieved. In this configuration, the image information scanned by the image scanner device is also sequentially transmitted to the printer, and the printer can sequentially form the image information on the recording paper. Therefore, the time from the start of the scanning of the original to the completion of the image forming on both surfaces of the recording paper can be effectively reduced. The connection unit is not limited to the connection with the printer via the network, but any suitable connecting method can be adopted such as direct connection with the printer through a Universal Serial Bus (USB), or the like.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. A copier comprising:
an image scanning device including:
a scanning unit arranged to scan image information of an original; and
an Automatic Document Feeder arranged to scan a first surface and a second surface of the original through the scanning unit; and
an image forming device including a duplex-printing portion arranged to form an image on a recording medium first from the second surface of the original; wherein
the Automatic Document Feeder includes:
an original tray on which the originals stacked with the first surfaces of the originals facing upward can be placed;
a separation unit arranged to separate an uppermost original from the originals stacked on the original tray;
a first double-surface path arranged to guide the original separated by the separation unit such that the second surface of the original passes through a scanning position of the scanning unit;
a second double-surface path arranged to reverse the original, which has passed through the first double-surface path and has had the second surface scanned, and to guide the original to the scanning position of the scanning unit so that the first surface of the original can be scanned;
a discharge path arranged to connect with the second double-surface path; and
a discharge tray arranged to connect with the discharge path.

2. The copier according to claim 1, wherein the Automatic Document Feeder includes:
a single-surface path arranged to reverse the original separated by the separation unit and guide the original to the scanning position of the scanning unit so that the first surface of the original can be scanned; and
a route switching unit arranged to switch a route of the original either to the single-surface path or to the first double-surface path.

3. The copier according to claim 2, wherein a portion of the single-surface path is shared with a portion of the second double-surface path.

4. The copier according to claim 3, wherein each of the single-surface path and the second double-surface path has a substantially U-shape including a turning portion, and a route from a junction portion, where a portion of the turning portion of the single-surface path and a portion of the turning portion of the second double-surface path join together, to the scanning position is shared.

5. The copier according to claim 2, wherein the Automatic Document Feeder includes an introducing path arranged to extend substantially horizontally from the original tray, and a downstream end portion of the introducing path is connected with an upstream end portion of the single-surface path and with an upstream end portion of the first double-surface path at the route switching unit.

6. The copier according to claim 5, wherein the single-surface path has a substantially U-shape including a turning portion, and the downstream end portion of the introducing path is connected with an upstream end portion of the discharge path via the single-surface path.

7. The copier according to claim 6, wherein the scanning position is located on a downstream side of the turning portion of the single-surface path.

8. The copier according to claim 1, wherein the discharge path is located below the first double-surface path.

9. The copier according to claim 2, wherein the first double-surface path is located below the single-surface path, and extends substantially linearly towards the scanning position.

10. An Automatic Document Feeder comprising:
an original tray on which originals stacked with first surfaces of the originals facing upward can be placed;
a separation unit arranged to separate an uppermost original from the originals stacked on the original tray;
a first double-surface path arranged to guide the original separated by the separation unit such that a second surface of the original passes through a scanning position of a scanning unit;
a second double-surface path arranged to reverse the original, which has passed through the first double-surface path and has had the second surface scanned, and to guide the original to the scanning position of the scanning unit so that the first surface of the original can be scanned;
a discharge path arranged to connect with the second double-surface path; and
a discharge tray arranged to connect with the discharge path.

11. An image scanning device comprising:
a scanning unit arranged to scan image information of an original;
an Automatic Document Feeder arranged to scan a first surface and a second surface of the original through the scanning unit; and
a connection unit arranged to enable connection with an image forming device including a duplex printing function; wherein the Automatic Document Feeder includes:
an original tray on which the originals stacked with the first surfaces of the originals facing upward can be placed;
a separation unit arranged to separate an uppermost original from the originals stacked on the original tray;
a first double-surface path arranged to guide the original separated by the separation unit such that the second surface of the original passes through a scanning position of the scanning unit;
a second double-surface path arranged to reverse the original, which has passed through the first double-surface path and has had the second surface scanned, and to guide the original to the scanning position of the scanning unit so that the first surface of the original can be scanned;
a discharge path arranged to connect with the second double-surface path; and
a discharge tray arranged to connect with the discharge path.

12. The image scanning device according to claim 11, wherein the Automatic Document Feeder includes:
a single-surface path arranged to reverse the original separated by the separation unit and guide the original to the scanning position of the scanning unit so that the first surface of the original can be scanned; and
a route switching unit arranged to switch a route of the original either to the single-surface path or to the first double-surface path.

13. The image scanning device according to claim 12, wherein a portion of the single-surface path is shared with a portion of the second double-surface path.

14. The image scanning device according to claim 13, wherein each of the single-surface path and the second double-surface path has a substantially U-shape including a turning portion, and a route from a junction portion, where a portion of the turning portion of the single-surface path and a portion of the turning portion of the second double-surface path join together, to the scanning position, is shared.

15. The image scanning device according to claim 12, wherein the Automatic Document Feeder includes an introducing path arranged to extend substantially horizontally from the original tray, and a downstream end portion of the introducing path is connected with an upstream end portion of the single-surface path and with an upstream end portion of the first double-surface path at the route switching unit.

16. The image scanning device according to claim 15, wherein the single-surface path has a substantially U-shape including a turning portion, and the downstream end portion of the introducing path and an upstream end portion of the discharge path are connected via the single-surface path.

17. The image scanning device according to claim 16, wherein the scanning position is located on a downstream side of the turning portion of the single-surface path.

18. The image scanning device according to claim 11, wherein the discharge path is located below the first double-surface path.

19. The image scanning device according to claim 12, wherein the first double-surface path is located below the single-surface path, and extends substantially linearly towards the scanning position.

20. A method for copying, comprising the steps of:
scanning, through one scanning unit, an image on a front surface and an image on a back surface of an original that is being transported, in which duplex scanning step, an uppermost original is sequentially separated from originals stacked on an original tray with first surfaces of the originals facing upward, and a duplex scanning operation is performed by one scanning unit first from a second surface of the original without a switchback operation being performed during transportation; and
forming a scanned image of the first surface and a scanned image of the second surface of the original on both surfaces of a recording medium, in which duplex printing step, the scanned image of the second surface of the original is formed into an image on the recording medium first.
